(19) United States
(12) Patent Application Publication
(10) Pub. No.: US 2003/0123839 A1
(43) Pub. Date: Jul. 3, 2003

(54) Low modulus, high tensile strength optical fiber coating

(76) Inventors: Kevin Y. Chou, Painted Post, NY (US); Steven R. Givens, Painted Post, NY (US); David N. Schissel, Painted Post, NY (US)

Correspondence Address: CORNING INCORPORATED, SP-TI-3-1, CORNING, NY, 14831

(21) Appl. No.: 09/916,536

(22) Filed: Jul. 27, 2001

(51) Int. Cl. G02B 6/02; C08F 2/46; C08G 18/67; C08L 75/00; C08L 75/08; C08L 75/04

(52) U.S. Cl. 385/145; 522/90; 522/96; 522/97; 522/181; 385/123; 528/75; 525/455; 525/123

(57) ABSTRACT

A coating composition includes at least one oligomer including a polyol soft block having a number average molecular weight of more than about 4000, and at least one reactive monomer. The cured coating composition has a tensile strength of at least about 0.85 MPa and a Young's Modulus of less than about 1.3 MPa. The invention further includes an optical fiber having a primary coating layer with the aforementioned coating composition and a method for coating the optical fiber.

### BACKGROUND OF THE INVENTION

1. Field of the Invention

The present invention relates to a low modulus, high tensile strength coating composition for an optical fiber, an optical fiber prepared with such coating composition and a method for making an optical fiber that contains such coating.

2. Technology Review

Optical fibers have acquired an increasingly important role in the field of communications, frequently replacing existing copper wires. This trend has had a significant impact in the local area networks (i.e., for fiber-to-home uses), which has seen a vast increase in the usage of optical fibers. Further increases in the use of optical fibers in local loop telephone and cable TV service are expected, as local fiber networks are established to deliver ever greater volumes of information in the form of data, audio, and video signals to residential and commercial users. In addition, use of optical fibers in home and commercial business for internal data, voice, and video communications has begun and is expected to increase.

The fibers used in local networks are directly exposed to harsh conditions, including severe temperature and humidity extremes. Optical fibers typically contain a glass core, a cladding, and at least two coatings, i.e., a primary (or inner primary) coating and a secondary (or outer primary) coating. The primary coating has a room temperature Young's modulus of 1.5 to 10 MPa. The primary coating is applied directly to the cladding and, when cured, forms a soft, elastic, and compliant material which encapsulates the glass fiber. The primary coating serves as a buffer to cushion and protect the glass fiber core when the fiber is bent, cabled, or spooled. The secondary coating is applied over the primary coating and functions as a tough, protective outer layer that prevents damage to the glass fiber during processing and use. The secondary coating has a modulus of 500 to 1000 MPa.

An important function of an optical fiber coating is to minimize optical losses due to microbending induced by lateral forces on the fiber. The term microbending refers to random bends with a short period (<1 mm) and small amplitude (typically a few microns). Microbending may result from the lateral stresses arising when the fiber is wound on a drum, or cabled.

Literature regarding microbend loss has been focused primarily on Young's modulus, thermal expansion coefficient of the coatings, and T_{g} (glass transition temperature)/stress relaxation of the coatings. The T_{g} of primary coatings have been widely used to correlate with fiber microbend loss at low temperatures.

Polymers are viscoelastic materials, and their stiffness, as reflected by their modulus, is temperature dependent. When a polymer is cooled below its glass transition temperature its modulus will increase dramatically, resulting in a much stiffer material. Consequently, when an optical fiber is exposed to very low use temperatures, it is important that the inner primary coating remains above its T_{g} so that resistance to microbend induced attenuation is minimized.

Coating compositions for the primary coating normally include an oligomer and reactive diluents, usually a mixture of urethane/acrylate oligomers and acrylic co-monomers. The oligomers may be prepared by reacting relatively low molecular weight polyols with diisocyanates and capping these materials with acrylic functionality to facilitate curing using photogenerated free radicals. The properties of coatings prepared from these materials are dependent upon oligomer structure, and thus upon the type of polyol used. Coatings prepared using oligomers based upon high molecular weight polyols tend to have rather high viscosities, rendering the coatings unable to be applied to the drawn fiber in a concentric manner.

### SUMMARY OF THE INVENTION

In accordance with one aspect of the present invention there is provided a coating composition including at least one oligomer including a polyol soft block having a number average molecular weight of more than about 4000 and at least one reactive monomer. When cured, the coating has a tensile strength of at least about 0.85 MPa and a Young's Modulus of less than about 1.3 MPa.

In accordance with another aspect of the present invention there is provided a coated optical fiber including an optical fiber having a primary coating layer thereon including the polymerized product of at least one oligomer including a polyol soft block having a number average molecular weight of more than about 4000 and at least one reactive monomer. The cured coating has a tensile strength of at least about 0.85 MPa and a Young's Modulus of less than about 1.3 MPa.

In accordance with a further aspect of the present invention there is provided a method for making a coated optical fiber, including providing an optical fiber; coating the optical fiber with a polymerizable composition including at least one oligomer including a polyol soft block having a number average molecular weight of more than about 4000, and at least one reactive monomer; and polymerizing the composition under conditions effective to form a primary coating over the optical fiber such that the cured composition has a coating tensile strength of at least about 0.85 MPa and a Young's Modulus of less than about 1.3 MPa.

It is advantageous to provide primary coatings having as low a T_{g} as possible, but still with sufficient tensile strength to remain processable.

It is also an advantage of the present invention to provide a coating composition having at least one of the following properties of a low T_{g}, high refractive index, good mechanical properties, and is also suitable for use as a primary coating. The coating made from this composition has a significantly lower T_{g} than conventional compositions disclosed in the prior art, and the optical fiber using this composition yields excellent microbend performance at low temperatures.

Additional features and advantages of the invention will be set forth in the detailed description which follows, and in part will be readily apparent to those skilled in the art from that description or recognized by practicing the invention as described in the written description and claims hereof, as well as the appended drawings. It is to be understood that both the foregoing general description and the following detailed description are merely exemplary of the invention, and are intended to provide an overview or framework to understanding the nature and character of the invention as it is claimed.

### BRIEF DESCRIPTION OF THE FIGURE

FIG. 1 is a cross-sectional view of a dual coated optical fiber of the present invention.

FIG. 2 is a schematic representation of a method for making an optical fiber in accordance with the invention.

### DETAILED DESCRIPTION OF PREFERRED EMBODIMENTS

The present invention relates to a curable coating composition for a primary coating of an optical fiber. The composition includes at least one oligomer and at least one reactive monomer.

In a preferred embodiment, the present invention relates to a curable coating composition including at least one oligomer including a polyol soft block having a number average molecular weight of more than about 4000 and at least one reactive monomer, wherein the composition has a cured coating tensile strength of at least about 0.85 MPa and a Young's Modulus of less than about 1.3 MPa.

Preferably, the coating composition when cured has a Young's Modulus of about 1.28 MPa or less, more preferably about 1.25 MPa or less, and most preferably about 1 MPa or less.

Preferably, the coating composition when cured has a Young's Modulus of about 1.28 MPa or less and a tensile strength of at least about 1 MPa.

Through variation of the oligomers, and the polyols from which they are based, coatings of desired T_{g}, modulus, elongation, and the like can be prepared in accordance with the present invention. The mechanical properties of these coatings can be adjusted by the choice of the oligomer and the oligomer co-monomer. In order to provide coating formulations with a viscosity that is in a range suitable for processing, the viscous oligomers may be diluted with low viscosity, radiation curable materials with which the oligomers are compatible.

In addition, according to the Fox equation, the ultimate glass transition temperature of a cured coating will be a function of the glass transition temperatures of the components of the coating formulation from which it is made. Thus, a desirable co-monomer in an optical fiber coating would be a low viscosity material with a low homopolymer glass transition temperature, which can readily dissolve a urethane/acrylate oligomer and which does not negatively impact the mechanical properties of the cured coating. In addition to low T_{g} and suitable viscosity, the selection of such oligomer and co-monomer combinations may be influences by other requirements for optical fibers. The additional requirements include suitably high refractive index, good optical clarity, good resistance to water sensitivity under humid conditions, low water and oil absorption, high thermal and light resistance, and low extractables.

A non-exhaustive list of suitable oligomers include the following:

(1) HEA-H12MDI-PPG₄₀₀₀-H12MDI-HEA;

(2) HEA-H12MDI-PPG₄₀₀₀-H12MDI-PPG₄₀₀₀-H12MDI-HEA;

(3) HEA-(IPDI-PPG₂₀₀₀-IPDI)-T₂₀₀₀-(IPDI-PPG₂₀₀₀-IPDI)-HEA;

(4) HEA-(IPDI-T₂₀₀₀-IPDI)-PPG₂₀₀₀-(IPDI-T₂₀₀₀-IPDI)-HEA;

(5) HEA-(IPDI-PPG₂₀₀₀-IPDI)-BD-(IPDI-PPG₂₀₀₀-IPDI)-HEA;

(6) HEA-(IPDI-BD-IPDI)-PPG₂₀₀₀-(IPDI-BD-IPDI)-HEA;

(7) HEA-(IPDI-EG₄-IPDI)-PPG₂₀₀₀-(IPDI-EG₄-IPDI)-HEA; and

(8) HEA-H12MDI-PPG₈₀₀₀-H12MDI-HEA.

The above chemical abbreviations, as used above, have the following meaning: (1) HEA is a hydroxyethyl acrylate capping group, (2) IPDI is an isophorone diisocyanate, (3) PPG₂₀₀₀ is a poly(propylene glycol) with a Mₙ=2000, (4) T₂₀₀₀ is a poly(tetramethylene glycol) (commercially available as Terathane® from E. I. DuPont of Wilmington, Del.) with a Mₙ=2000, (5) BD is a 1,4 butanediol, (6) EG₄ is a tetraethylene gylcol, (7) PPG₄₀₀₀ is a poly(propylene glycol) with a Mₙ=4000 (commercially available as Acclaim 4200 from Bayer, Pittsburgh, Pa.), and (8) H12MDI is 4,4′-methylenebis(cyclohexylisocyanate) available as Desmoder W from Bayer). Preferably, the oligomer includes urethane groups (—N(C═O)O—) but yet is substantially devoid of a polyurea group (—N(C═O)N—). The soft block of the oligomer as used herein is each group of the oligomer except for the terminal acrylate and isocyanate groups. For example, the soft block of compound 1 above is PPG₄₀₀₀, for compound 2 is -PPG₄₀₀₀-H12MDI-PPG₄₀₀₀-, and the soft block of compound 3 is -PPG₂₀₀₀-IPDI-T₂₀₀₀-IPDI-PPG₂₀₀₀-. Preferably the polyols used in the synthesis of the above oligomers include a minimal amount of mono-functional contaminates. More preferably, the above polyols used to synthesis the above oligomers have a functionality of greater than 1 and even more preferably at least about 2.

A co-monomer is used in here to describe at least one monomer that is used in a coating combination with at least one oligomer. A non-exhaustive list of suitable co-monomers include the following:

(1) R₂—R₁—O—(CH₂CH₃CH—O)ₙ—COCH═CH₂,;

(2) R₁—O—(CH₂CH₃CH—O)ₙ—COCH═CH₂;

(3) R₂—R₁—O—(CH₂CH₂CH₂—O)ₙ—COCH═CH₂;

(4) [(CH₂CH₃CH—O)ₙ—(R₃ CH₂—O)_{b}]ₓH;

(5) [(CH₂(R₃)CH—O)ₙ—(CH₂CH₂—O)_{b}]ₓH; and

(6) [(CH₂R₄CH—O)ₙ—(R₃ CH₂—O)_{b}]ₓH.

Where R₁ and R₂ are aliphatic or aromatic or mixtures of both, and n=1 to 10 and R₃ and R₄ can be an alkyl or alkylene oxide group which can be acrylated to provide mono or multifunctional acrylates. The coefficients “a”, “b”, and “x” can be any positive whole integer. Preferably each co-monomer includes at least one n-propyl, isopropyl, or substituted isopropyl group. Examples of a monomer with a substituted isopropyl group are shown below:

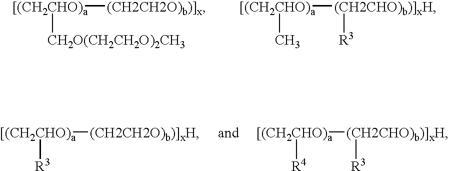

where R³ and R⁴ are alkyl, alkyl oxide, or alkylene oxide groups that can acrylated to provide mono- or multifunctional acrylates.

In one embodiment, the oligomer is made using urethane acrylate oligomers prepared from a high molecular weight, low molecular weight distribution polyether polyol. As used herein a low molecular weight distribution means an M_{w}/Mₙ of less than about 1.4 or less, preferably about 1.3 or less, more preferably about 1.2 or less, and even more preferably about 1.1 or less. A high molecular weight means an Mₙ of at least about 2000, preferably at least about 4000, more preferably at least about 6000, and even more preferably at least about 8000. The units for the aforementioned molecular weights is Daltons. Coatings which include an oligomer, which comprises the aforementioned polyol, possess very low glass transition temperatures, preferably less than about −35° C., more preferably less than about −40° C., even more preferably less than about −45° C., and most preferably less than about −50° C., along with good mechanical properties such as a low modulus, preferably less than about 1.3 MPa, more preferably less than about 1.2 MPa, even more preferably less than about 1.1 MPa, and most preferably less than about 1.0 MPa, and exceptionally high tensile strength, preferably more than about 0.85 MPa, more preferably more than about 1.00 MPa, even more preferably more than about 1.20 MPa, and most preferably more than about 1.40 MPa., and high elongation, preferably more than about 120%, more preferably more than about 140%, even more preferably more than about 160%, and most preferably more than about 180%, while still having viscosities low enough, preferably less than about 80 poises, more preferably less than about 70 poises, even more preferably less than about 60 poises, and most preferably less than about 50 poises, to allow them to be easily processed. The aforementioned viscosities are measured at about 25° C. Fibers made with the above primary coating have demonstrated advantageous microbend resistance when compared to fibers made with a standard coating.

In this embodiment, preferred coatings were prepared using urethane/acrylate oligomers made from a high molecular weight polypropylene glycol having a relatively narrow molecular weight distribution, e.g., a M_{w}/Mₙ of less than about 1.1. Preferred is Bayer Acclaim 4200, molecular weight approximately 4000. The single and double polyol block oligomers are shown below:

HEA˜H12MDI˜PPG₄₀₀₀˜H12MDI˜HEA (A)

HEA˜H12MDI=PPG₄₀₀₀˜H12MDI˜PPG₄₀₀₀˜H12MDI˜HEA (B)

In these structures PPG₄₀₀₀ refers to a polypropylene glycol having a molecular weight of at least about 4000 Daltons. The preferred PPG₄₀₀₀ is the Acclaim 4200. The preferred H12MDI is Desmoder W (Bayer, 4,4′-methylenebis(cyclohexylisocyanate). HEA is 2-hydroxyethyl acrylate.

In another embodiment, this invention relates to the use of an oligomer and co-monomers containing poly(propylene glycol) segments in combination with polyol block based urethane/acrylate oligomers to prepare UV light curable primary optical fiber coatings possessing low Young's modulus, e.g., preferably less than about 1.3 MPa, more preferably less than about 1.2 MPa, even more preferably less than about 1.1 MPa, and most preferably less than about 1.0 MPa, very low glass transition temperatures, e.g., preferably less than about −35° C., more preferably less than about −40° C., even more preferably less than about −45° C., and most preferably less than about −50° C., and satisfactory coating viscosities, e.g., about 80 poises, more preferably less than about 70 poises, even more preferably less than about 60 poises, and most preferably less than about 50 poises, to allow them to be easily processed. The aforementioned viscosities are measured at about 25° C. Optical fibers coated with these materials show a greater resistance to microbend induced attenuation at low fiber use temperatures.

A preferred primary coating composition having a low T_{g}, high refractive index, high tensile strength, high elongation, and low modulus can be obtained from combining (1) 20-80 wt % of a propylene oxide (e.g. n-propylene oxide or iso-propylene oxide or a mixture of both) containing monofunctional acrylate having a structure, for example, such as

R₂—R₁—O—(CH₂CH₃CH—O)ₙ—COCH═CH₂, or

R₁—O—(CH₂CH₃CH—O)ₙ—COCH═CH₂

where R₁ and R₂ are aliphatic or aromatic or mixtures of both, and n=1 to 10 and having (2) 20-80 wt % of urethane acrylate oligomers, for example, such as

HEA˜(IPDI˜PPG₂₀₀₀˜IPDI)˜T₂₀₀₀˜(IPDI˜PPG₂₀₀₀˜IPDI)˜HEA

where HEA is hydroxyethyl acrylate, IPDI is isophorone diisocyanate, PPG₂₀₀₀ is poly(propylene glycol) with an average Mₙ of 2000 and T₂₀₀₀ is poly(tetramethylene glycol) (commercially available as Terathane®) with an average Mₙ of 2000. The soft block includes PPG₂₀₀₀˜IPDI˜T₂₀₀₀˜IPDI˜PPG₂₀₀₀. This mixture will produce a coating having a T_{g} much lower than conventional acrylate coatings. Benefits of this coating can be realized as providing up to a 25° C. lower T_{g} than conventional coatings and still maintaining a high refractive index, good mechanical strength, good flexibility, good adhesion, good hydrolytic and good thermal stability. In addition, this coating composition has a low viscosity, allowing the coating to be processed at low temperatures and at a higher speed.

Optionally, the coating composition of the present invention can include at least a second oligomer. Suitable ethylenically unsaturated second oligomers for primary coatings include polyether urethane acrylate oligomers (e.g., CN986 available from Sartomer Company, Inc., (West Chester, Pa.)) and BR3731 and STC3-149 available from Bomar Specialty Co. (Winstead, Conn.)), acrylate oligomers based on tris(hydroxyethyl)isocyanurate, (available from Sartomer Company, Inc.), (meth)acrylated acrylic oligomers, (available from Cognis (Ambler, Pa.), polyester urethane acrylate oligomers (e.g., CN966 and CN973 available from Sartomer Company, Inc. and BR7432 available from Bomar Specialty Co.), polyurea urethane acrylate oligomers (e.g., oligomers disclosed in U.S. Pat. Nos. 4,690,502 and 4,798,852 to Zimmerman et al., U.S. Pat. No. 4,609,718 to Bishop, and U.S. Pat. No. 4,629,287 to Bishop et al., all of which are hereby incorporated by reference), polyether acrylate oligomers (e.g., Genomer 3456 available from Rahn AG (Zurich, Switzerland), polyester acrylate oligomers (e.g., Ebecryl 80, 584, and 657 available from UCB Radcure (Atlanta, Ga.)), polyurea acrylate oligomers (e.g., oligomers disclosed in U.S. Pat. Nos. 4,690,502 and 4,798,852 to Zimmerman et al., U.S. Pat. No. 4,609,718 to Bishop, and U.S. Pat. No. 4,629,287 to Bishop et al., the specifications of which are hereby incorporated by reference), epoxy acrylate oligomers (e.g., CN120 available from Sartomer Company, Inc., and Ebecryl 3201 and 3604 available from UCB Radcure), hydrogenated polybutadiene oligomers (e.g., Echo Resin MBNX available from Echo Resins and Laboratory (Versailles, Mo.)), and combinations thereof.

Suitable reactive monomers include ethoxylated acrylates, ethoxylated nonylphenol monoacrylates, propylene oxide acrylates, n-propylene oxide acrylates, iso-propylene oxide acrylates, monofunctional acrylates, and combinations thereof. Preferred monomers include:

(1) R₂—R₁—O—(CH₂CH₃CH—O)ₙ—COCH═CH₂, where R₁ and R₂ are aliphatic, aromatic, or a mixture of both, and n=1 to 10, and

(2) R₁—O—(CH₂CH₃CH—O)ₙ—COCH═CH₂, where R₁ is aliphatic or aromatic, and n=1 to 10.

Preferably, the composition contains at least one reactive monomer, although more than one monomer can be introduced into the composition. Typically, when multiple types of monomers are used, one monomer is chosen for its ability to dissolve the polymer and a second monomer may be chosen for its ability to achieve a desired rate of cure. When a single monomer is desired, preferably the monomer is chosen for its ability to dissolve the oligomer.

Suitable optional second monomers include at least ethoxylated acrylates, ethoxylated nonylphenol monoacrylates, monofunctional acrylates, and combinations thereof. Specific examples include ethylenically unsaturated monomers including lauryl acrylate (e.g., SR335 available from Sartomer Company, Inc., Ageflex FA12 available from CPS Chemical Co. (Old Bridge, N.J.), and Photomer 4812 available from Cognis f.k.a. Henkel (Ambler, Pa.)), ethoxylatednonylphenol acrylate (e.g., SR504 available from Sartomer Company, Inc. and Photomer 4003 available from Cognis), caprolactone acrylate (e.g., SR495 available from Sartomer Company, Inc., and Tone M100 available from Union Carbide Company (Danbury, Conn.)), phenoxyethyl acrylate (e.g., SR339 available from Sartomer Company, Inc., Ageflex PEA available from CPS Chemical Co., and Photomer 4035 available from Cognis), isooctyl acrylate (e.g., SR440 available from Sartomer Company, Inc. and Ageflex FA8 available from CPS Chemical Co.), tridecyl acrylate (e.g., SR489 available from Sartomer Company, Inc.), phenoxyglycidyl acrylate (e.g., CN131 available from Sartomer Company, Inc.), lauryloxyglycidyl acrylate (e.g., CN130 available from Sartomer Company, Inc.), isoborynl acrylate (e.g., SR506 available from Sartomer Company, Inc. and Ageflex IBOA available from CPS Chemical Co.), tetrahydrofurfuryl acrylate (e.g., SR285 available from Sartomer Company, Inc.), stearyl acrylate (e.g., SR257 available from Sartomer Company, Inc.), isodecyl acrylate (e.g., SR395 available from Sartomer Company, Inc. and Ageflex FA10 available from CPS Chemical Co.), 2-(2-ethoxyethoxy)ethyl acrylate (e.g., SR256 available from Sartomer Company, Inc.), and combinations thereof.

The composition includes an oligomer or mixture of oligomers that may or may not be chemically cross-linked when cured. The composition can include an oligomer component in an amount of from about 5% by wt. to about 95% by wt., preferably from about 25% by wt. to about 75% by wt., and most preferably from about 40% by wt. to about 60% by wt.

The composition can include reactive monomers in an amount of from about 5% by wt. to about 95% by wt., preferably from about 25% by wt. to about 65% by wt., and most preferably from about 35% by wt. to about 55% by wt.

Optical fiber coating compositions may also contain a polymerization initiator which is suitable to cause polymerization (i.e., curing) of the composition after its application to a glass fiber. Polymerization initiators suitable for use in the primary coating compositions of the present invention include thermal initiators, chemical initiators, electron beam initiators, and photoinitiators. Particularly preferred are the photoinitiators. For most acrylate-based coating formulations, conventional photoinitiators, such as ketonic photoinitiating and/or phosphine oxide additives, are preferred. When used in the compositions of the present invention, the photoinitiator is present in an amount sufficient to provide rapid ultraviolet curing.

The composition can include a photoinitiator in an amount of up to about 10% by wt., preferably from about 0.5% by wt. to about 6% by wt., and more preferably from about 2% by wt. to about 4% by wt. Preferably the composition includes a photoinitiator.

The photoinitiator, when used in a small but effective amount to promote radiation cure, provides reasonable cure speed without causing premature gelation of the coating composition. A desirable cure speed is any speed sufficient to cause substantial curing of the coating materials. A preferred dosage for coating thicknesses of about 25-35 μm is, e.g., less than about 1.0 J/cm², preferably less than about 0.5 J/cm².

Suitable photoinitiators include 1-hydroxycyclohexylphenyl ketone (e.g., Irgacure 184 available from Ciba Specialty Chemical (Hawthorne, N.Y.), (2,6-dimethoxybenzoyl)-2,4,4-trimethylpentyl phosphine oxide (e.g., commercial blends Irgacure 1800, 1850, and 1700 available from Ciba Specialty Chemical), 2,2-dimethoxyl-2-phenyl acetophenone (e.g., Irgacure 651, available from Ciba Specialty Chemical), bis(2,4,6-trimethyl benzoyl)phenyl-phosphine oxide (Irgacure 819), (2,4,6-trimethylbenzoyl)diphenyl phosphine oxide (Lucerin TPO, available from BASF (Munich, Germany)), ethoxy (2,4,6-trimethylbenzoyl)phenyl phosphine oxide (Lucerin TPO-L from BASF), and combinations thereof.

As used herein, the weight percent of a particular component refers to the amount introduced into the bulk composition excluding an additional adhesion promoter and other additives. The amount of additional adhesion promoter and various other additives that are introduced into the bulk composition to produce a composition of the present invention is listed in parts per hundred. For example, a monomer, oligomer, and photoinitiator are combined to form the bulk composition such that the total weight percent of these components equals 100 percent. To this bulk composition, an amount of an additional adhesion promoter other than the bulk components, for example 1.0 part per hundred, can be employed in excess of the 100 weight percent of the bulk composition.

Preferably, an adhesion promoter is present in the coating composition. In a preferred embodiment, an adhesion promoter is present in the composition in an amount between about 0.1 to about 10 parts per hundred, more preferably between about 0.25 to about 4 parts per hundred, most preferably between about 0.5 to about 3 parts per hundred. Suitable adhesion promoters include alkoxysilanes, organotitanates, and zirconates. Preferred adhesion promoters include 3-mercaptopropyltrialkoxysilane (e.g., 3-MPTMS, available from United Chemical Technologies (Bristol, Pa.)), bis(trialkoxysilylethyl)benzene, acryloxypropyltrialkoxysilane, methacryloxypropyltrialkoxysilane, vinyltrialkoxysilane, bis(trialkoxysilylethyl)hexane, allyltrialkoxysilane, styrylethyltrialkoxysilane, and bis(trimethoxysilylethyl)benzene (available from Gelest (Tullytown, Pa.)); see U.S. patent application Ser. No. 09/301,814, filed Apr. 29, 1999, which is hereby incorporated by reference in its entirety.

In addition to the above-described components, the primary coating composition of the present invention can optionally include any number of additives, such as reactive diluents, antioxidants, catalysts, and other stabilizers and property-enhancing additives. Some additives can operate to control the polymerization process, thereby affecting the physical properties (e.g., modulus, glass transition temperature) of the polymerization product formed from the primary coating composition. Others can affect the integrity of the polymerization product of the primary coating composition (e.g., protect against de-polymerization or oxidative degradation). Optionally, the additive includes a carrier.

The carrier is preferably a carrier which functions as a carrier surfactant or ambiphilic reactive or non-reactive surfactant. Reactive surfactants which are partially soluble or insoluble in the composition are particularly preferred. Without being bound to a particular theory, it is believed that carriers interact with the compound containing a reactive silane by depositing such compounds on the glass fiber, where it is allowed to react. It is desirable for the carrier to be present in an amount between about 0.01 to about 10 parts per hundred, more preferably about 0.25 to about 3 parts per hundred.

Suitable carriers, more specifically carriers which function as reactive surfactants, include polyalkoxypolysiloxanes. A preferred carrier is available from Goldschmidt Chemical Co. (Hopewell, Va.) under the tradename Tegorad 2200, and reactive surfactant Tegorad 2700 (acrylated siloxane) also from Goldschmidt Chemical Co.

Other classes of suitable carriers are polyols and non-reactive surfactants. Examples of suitable polyols and non-reactive surfactants include polyol Acclaim 3201 (poly(ethylene oxide-co-propylene oxide)) available from Bayer (formerly known as Lyondel), Newtown Square, Pa., and non-reactive surfactants Tegoglide 435 (polyalkoxy-polysiloxane) available from Goldschmidt Chemical Co. The polyol or non-reactive surfactants may be present in a preferred amount between about 0.01 pph to about 10 pph. Suitable carriers may also be ambiphilic molecules. An ambiphilic molecule is a molecule that has both hydrophilic and hydrophobic segments. The hydrophobic segment may alternatively be described as a lipophilic (fat/oil loving) segment.

A tackifier is also an example of a suitable carrier. A tackifier is a molecule that can modify the time-sensitive rheological property of a polymer product. In general a tackifier additive will make a polymer product act stiffer at higher strain rates or shear rates and will make the polymer product softer at low strain rates or shear rates. A tackifier is an additive commonly used in the adhesives industry, that enhances the ability of a coating to create a bond with an object that the coating is applied upon. For additional background regarding tackifiers and tackifier resins, the Handbook of Pressure Sensitive Adhesive Technology, 3^{rd} Edition, (Warwick, R.I.) (1999) is incorporated herein by reference, see pages 36, 37, 57-61, 169, 173, 174, and 609-631.

Preferred tackifiers are those classified as a terpene base resin, coumarone base resin, petroleum resin, hydrogenated petroleum resin, styrene resin, phenol resins, or rosin base resin. It is preferred that the tackifiers are nonepoxidized. The rosin base resins include unmodified rosin (e.g., wood, gum, or tall oil) and rosin derivatives. Rosin base resins can be classified by their rosin acids, which are either an abietic acid or a pimaric acid. Abietic acid type rosins are preferred. Rosin derivatives include polymerized rosin, disproportionated rosin, hydrogenated rosin, and esterified rosin. Representative examples of such rosin derivatives include pentaerythritol esters of tall oil, gum rosin, wood rosin, or mixtures thereof.

The terpene base resins include terpene polymers of α-pinene, β-pinene, dipentel, limonene, myrcene, bornylene and camphene, and phenol-modified terpene base resins obtained by modifying these terpene base resins with phenols.

The coumarone base resins include, for example, coumarone-indene resins and phenol-modified coumarone-indene resins.

Petroleum and hydrogenated petroleum resins include aliphatic petroleum resins, alicyclic petroleum resins, aromatic petroleum resins using styrene, α-methylstyrene, vinyltoluene, indene, methylindene, butadiene, isoprene, piperylene and pentylene as raw materials, and homopolymers or copolymers of cyclopentadiene. The petroleum resins are polymers using fractions having a carbon number of 5 to 9 as main components.

The styrene base resins include homopolymers which are low molecular weight polymers comprising styrene as a principal component, and copolymers of styrene with, for example, α-methylstyrene, vinyltoluene, and butadiene rubber.

The phenol base resins include reaction products of phenols such as phenol, cresol, xylenol, resorcinol, p-tert-butylphenol, and p-phenylphenol with aldehydes such as formaldehyde, acetaldehyde and furfural, and rosin-modified phenol resins.

A more preferred tackifier is Uni-tac® R-40 (hereinafter “R-40”) available from International Paper Co., Purchase, N.Y. R-40 is a tall oil rosin, which contains a polyether segment, and is from the chemical family of abietic esters. Preferably, the tackifier is present in the composition in an amount between about 0.01 to about 10 parts per hundred, more preferred in the amount between about 0.05 to about 10 parts per hundred. A suitable alternative tackifier is the Escorez series of hydrocarbon tackifiers available from Exxon. For additional information regarding Escorez tackifiers, the specification of U.S. Pat. No. 5,652,308 is hereby incorporated by reference in its entirety. The aforementioned carriers may also be used in combination. For additional explanation regarding the carrier U.S. patent application Ser. No. 09/476,151 filed on or about Dec. 29, 1999 by Chien et al. is incorporated herein by reference in its entirety. The aforementioned carriers may also be used in combination.

A residual amount of n-dibutyltin catalyst may be present in the coating. Dibutyltin is a catalyst used to catalyze the formation of urethane bonds in the oligomer component. A preferred catalyst is a dibutyl tin dilaurate.

A preferred antioxidant is thiodiethylene bis(3,5-di-tert-butyl)-4-hydroxyhydrocinnamate) (e.g., Irganox 1035, available from Ciba Specialty Chemical).

The composition can further include additional additives such as waxes, lubricants, slip agents as well as other additives known in the art.

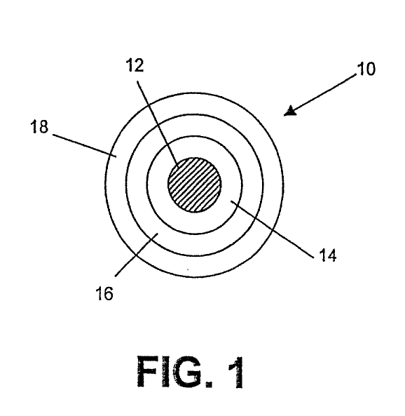

Referring to FIG. 1, the optical fiber 10 includes a glass core 12, a cladding layer 14 surrounding and adjacent to the glass core 12, a primary coating material 16 which adheres to the cladding layer 14, and one or more secondary (or outer) coating materials 18 surrounding and adjacent to the primary coating material 16. Any conventional material can be used to form the glass core 12, such as those described in U.S. Pat. No. 4,486,212 to Berkey, which is hereby incorporated by reference in its entirety. The core is typically a silica glass having a cylindrical cross section and a diameter ranging from about 5 to about 10 μm for single-mode fibers and about 20 to about 100 μm for multi-mode fibers. The core can optionally contain varying amounts of other material such as, e.g., oxides of titanium, thallium, germanium, and boron, which modify the core's refractive index. Other dopants which are known in the art can also be added to the glass core to modify its properties.

The cladding layer 14 preferably has a refractive index which is less than the refractive index of the core. A variety of cladding materials, both plastic and glass (e.g., silicate and borosilicate glasses) are used in constructing conventional glass fibers. Any conventional cladding materials known in the art can be used to form the cladding layer 14 in the optical fiber of the present invention.

The glass core 12 and cladding layer 14, which together form the glass fiber, can be formed according to a number of processes known in the art. In many applications, the glass core 12 and cladding layer 14 have a discernible core-cladding boundary. Alternatively, the core and cladding layer can lack a distinct boundary. The optical fibers of the present invention can contain these or any other conventional core-cladding layer configuration now known or hereafter developed.

The secondary coating material(s) 18 is typically the polymerization (i.e., cured) product of a coating composition that contains urethane acrylate liquids whose molecules become cross-linked when polymerized. Other suitable materials for use in secondary coating materials, as well as considerations related to selection of these materials, are well known in the art and are described in U.S. Pat. Nos. 4,962,992 and 5,104,433 to Chapin, which are hereby incorporated by reference in their entirety. Various additives that enhance one or more properties of the coating can also be present, including the above-mentioned additives incorporated in the compositions of the present invention.

The secondary coating material(s) 18 is typically the polymerization (i.e., cured) product of a coating composition that contains urethane acrylate liquids whose molecules become cross-linked when polymerized. Irrespective of the type of secondary coating employed, it is preferred that the outer surface of the secondary coating material 18 not be tacky so that adjacent convolutions of the optic fiber (i.e., on a process spool) can be unwound.

The secondary coating of the optical fiber of the present invention can optionally include a coloring material, such as a pigment or dye, or an additional colored ink coating.

In terms of optical properties, the basic requirement for an optical fiber coating is to have a primary coating having a refractive index higher than that of the cladding. In a typical optical fiber, the refractive index values for the glass core and the cladding are 1.447 and 1.436 respectively. As can be seen in the Examples below, the values of refractive index of two new recipes were quite high at around 1.455, though they were slightly lower than the control.

The optical fibers of the present invention can also be formed into a optical fiber ribbon which contains a plurality of substantially aligned, substantially coplanar optic fibers encapsulated by a matrix material. The matrix material can be made of a single layer or of a composite construction. Suitable matrix materials include polyvinyl chloride as well as those materials known to be useful as secondary coating materials. Preferably the matrix material is the polymerization product of the composition used to form the secondary coating material.

In accordance with another embodiment, the present invention relates to a coated optical fiber having at least one coating layer thereon, wherein the primary coating layer includes the polymerized product of at least one oligomer and at least one reactive monomer. The oligomer preferably includes a polyol soft block having a number average molecular weight of more than about 4000 Daltons, more preferably more than about 6000 Daltons, and most preferably more than about 8000 Daltons. The cured coating preferably has a tensile strength of at least about 0.85 MPa and a Young's Modulus of less than about 1.3 MPa.

In accordance with another embodiment, the present invention relates to a method for making a coated optical fiber. The method includes providing an optical fiber and coating the optical fiber with a coating composition. The coating composition includes at least one oligomer and at least one reactive monomer of the present invention. The coating composition of the present invention is then polymerized under conditions effective to cure the coating. This method can be effected by standard methods with the use of a primary coating composition of the present invention.

Briefly, the process involves providing the glass fiber (core 12 and cladding layer 14), coating the glass fiber with the primary coating composition of the present invention, and polymerizing the composition to form the primary coating material 16. Optionally, a secondary coating composition can be applied to the coated fiber either before or after polymerizing the primary coating. When applied after polymerizing the primary coating, a second polymerization step is preferably employed.

The core and cladding layer are typically produced in a single operation by methods which are well known in the art. Suitable methods include: the double crucible method as described, for example, in Midwinter, Optical Fibers for Transmission, New York, John Wiley, pp. 166-178 (1979), which is hereby incorporated by reference in its entirety; rod-in-tube procedures; and doped deposited silica processes, also commonly referred to as chemical vapor deposition (“CVD”) or vapor phase oxidation. A variety of CVD processes are known and are suitable for producing the core and cladding layer used in the optical fibers of the present invention. They include external CVD processes: Blankenship et al., “The Outside Vapor Deposition Method of Fabricating Optical Waveguide Fibers,” IEEE J. Quantum Electron., 18:1418-1423 (1982), which is hereby incorporated by reference in its entirety; axial vapor deposition processes: Inada, “Recent Progress in Fiber Fabrication Techniques by Vapor-phase Axial Deposition,” IEEE J. Quantum Electron. 18:1424-1431 (1982), which is hereby incorporated by reference in its entirety; and modified CVD or inside vapor deposition: Nagel et al., “An Overview of the Modified Chemical Vapor Deposition (MCVD) Process and Performance,” IEEE J. Quantum Electron. 18:459-476 (1982), which is hereby incorporated by reference in its entirety.

The primary and optional secondary coating compositions are coated on a glass fiber using conventional processes. The glass fibers are drawn from a specially prepared, cylindrical glass perform which has been locally and symmetrically heated to a temperature, e.g., of about 2000° C. As the preform is heated, such as by feeding the preform into and through a furnace, a glass fiber is drawn from the molten material. The primary and optional secondary coating compositions are applied to the glass fiber after it has been drawn from the preform, preferably immediately after cooling. The coating compositions are then cured to produce the coated optical fiber. The method of curing can be thermal, chemical, or radiation induced, such as by exposing the un-cured coating composition on the glass fiber to ultraviolet light or electron beam, depending upon the nature of the coating composition(s) and polymerization initiator being employed. It is frequently advantageous to apply both the primary coating composition and any secondary coating compositions in sequence following the draw process. One method of applying dual layers of coating compositions to a moving glass fiber is disclosed in U.S. Pat. No. 4,474,830 to Taylor, which is hereby incorporated by reference in its entirety. Of course, the primary coating composition can be applied and cured to form the primary coating material 16, then the secondary coating composition(s) can be applied and cured to form the secondary coating material 18.

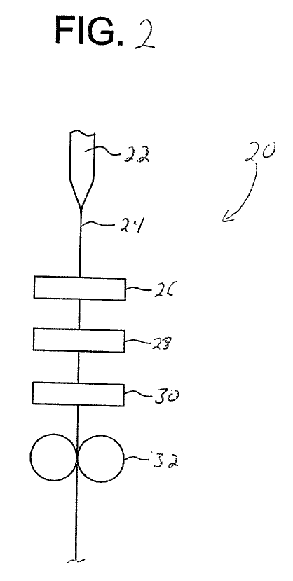

FIG. 2 is a schematic representation of one of the preferred processes for drawing and coating an optical fiber. The partially sintered preform 22 is softened and drawn into a fiber 24. The uncoated fiber is then drawn through two coating dies 26 and 28 where the primary and secondary coatings, respectively, are applied to the fiber. The wet coated fiber is then cured by a bank of UV lamps 30. The fiber 24 is drawn from the preform and through the coating dies by a pair of tractors 32.

Coated optical fibers 10 of the present invention can also be used to prepare an optical fiber ribbon using conventional methods of preparation. For example, a plurality of coated optical fibers 10 are substantially aligned in a substantially coplanar relationship to one another and, while remaining in this relationship, the coated optical fibers are coated with a composition that is later cured to form the ribbon matrix material. The composition used to prepare the ribbon matrix material can be the same as the secondary coating composition, or any other suitable composition known in the art. Methods of preparing optical fiber ribbons are described in U.S. Pat. No. 4,752,112 to Mayr and U.S. Pat. No. 5,486,378 to Oestreich et al., which are each hereby incorporated by reference in their entirety.

The invention will be illustrated in greater detail by the following specific examples. It is understood that these examples are given by way of illustration and are not meant to limit the disclosure or the claims to follow. All percentages in the examples, and elsewhere in the specification, are by weight unless otherwise specified.

### EXAMPLE 1

A primary optical fiber coating was prepared using urethane/acrylate oligomers made from a high molecular weight polypropylene glycol (Bayer Acclaim 4200, molecular weight approximately 4000) having a molecular weight distribution of less than 1.1. The single and double polyol block oligomers shown below were prepared;

HEA˜H12MDI-PPG₄₀₀₀˜H12MDI˜HEA (A)

HEA˜H12MDI-PPG₄₀₀₀˜H12MDI˜PPG₄₀₀₀˜H12MDI˜HEA (B)

In these structures PPG₄₀₀₀ refers to the Acclaim 4200, H12MDI is Desmoder W (Bayer, 4,4′-methylenebis(cyclohexylisocyanate), and HEA is 2-hydroxyethyl acrylate. While not being bound by theory, it was anticipated that the more narrow molecular weight distribution of the Acclaim 4200 would lead to oligomers having a more uniform structure which, in turn, would lead to enhanced alignment and increased hydrogen bonding interactions between the oligomeric units in a cured polymer network. Increased network tensile strength was in fact observed. In addition, we found that through proper use of co-monomers the viscosities of coatings containing these high molecular weight polyol based oligomers could be maintained in a desirable range while also maintaining excellent mechanical and thermal properties in the cured polymer networks.

To prepare oligomer (A), a mixture of 13.12 g (0.050 mole) of Desmoder W, 182 mg of butylated hydroxytoluene (BHT) antioxidant and 188 mg of di-n-butyltin dilaurate was placed in a 500 mL resin reactor and stirred under nitrogen. The contents of the reactor were held at room temperature and 100.0 g (0.025 mole) of Acclaim 4200 was added dropwise over 1 hour. The reactor was heated to an internal temperature of approx. 80 deg. C. for 1 hour, and then was recooled to approx. 70 deg. C. At this time 5.81 g (0.050 mole) of 2-hydroxyethyl acrylate was added dropwise over 3 min. After the addition was complete, the reactor internal temperature was raised to approx. 80 deg. C. and held there for 2 hours to complete the reaction.

To prepare oligomer (B), a mixture of 9.84 g (0.038 mole) of Desmoder W, 170 mg of butylated hydroxytoluene (BHT) antioxidant and 173 mg of di-n-butyltin dilaurate was placed in a 500 ml resin reactor and stirred under nitrogen. The contents of the reactor were held at room temperature and 100.0 g (0.025 mole) of Acclaim 4200 was added dropwise over 1 hour. The reactor was heated to an internal temperature of approx. 80 deg. C. for 1 hour, and then was recooled to approx. 65 deg. C. At this time 2.90 g (0.025 mole) of 2-hydroxyethyl acrylate was added dropwise over 2.5 min. After the addition was complete, the reactor internal temperature was raised to approx. 80 deg. C. and held there for 2 hours to complete the reaction.

The coatings were prepared by weighing the oligomer (52% by weight) into a plastic mixing container followed by the addition of Photomer 4003 (Cognis, ethoxylated nonylphenol acrylate) and/or Photomer 8061 (Cognis, propoxylated methylether acrylate) as co-monomer(s) (45%), and Irgacure 1850 (3%). The specific formulations of oligomer and co-monomer for each composition tested are set forth in the Table 1-1 below. The ingredients were mixed and then the container was placed in an oven and held at approximately about 50-55 deg. C. for at least about 12 hours. The coatings were removed from the oven after at least about 8 hours and stirred. Wet films were cast on silicone release paper with the aid of a draw-down box having an about 5 mil gap thickness. Films were cured using a Fusion Systems UV curing apparatus with a 600 watt/in D-bulb (50% power, 10 ft/min belt speed, nitrogen purge). Cured film thickness was between about 3 and about 4 mil.

The films were allowed to age (23 deg. C, 50% rh) for at least 16 hours prior to testing. Film samples were cut to a specified length and width (about 15 cm×about 1.3 cm). Young's modulus, tensile strength at break, and elongation at break were measured using an Instron 4200 tensile tester. Films were tested at an elongation rate of 2.5 cm/min starting from an initial jaw separation of 5.1 cm. Glass transition temperatures of the cured films were determined by the tanδ curves measured on a Seiko-5600 DMS in tension at a frequency of 1 Hz. Thermal and mechanical properties (tested in accordance with ASTM 82-997) of the cured films are given in the table 1-1 below;

TABLE 1-1

| | | Viscosity | | | | |
|---|---|---|---|---|---|---|
| | | @ 25 | Young's | Tensile | | |
| | Refractive | deg. C. | Modulus | Strength | % | T_{g} |
| Composition^{a} | Index | (Poise) | (MPa) | (MPa) | Elongation | (° C.)^{b} |
| 52 (A)/ | 1.4790 | 71 | 1.28 | 1.39 | 134 | −36 |
| 45 Photomer 4003 | | | | | | |
| 52 (A)/ | 1.4520 | 13 | 1.10 | 1.27 | 128 | −53 |
| 45 Photomer 8061 | | | | | | |
| 52 (A)/ | 1.4641 | 23 | 1.28 | 1.82 | 154 | −45 |
| 22.25 Photomer 8061/ | | | | | | |
| 22.25 Photomer 4003 | | | | | | |
| 52 (B)/ | 1.4776 | 193 | 0.81 | 1.85 | 263 | −38 |
| 45 Photomer 4003 | | | | | | |
| 52 (B)/ | 1.4510 | 37 | 0.74 | 1.99 | 261 | −55 |
| 45 Photomer 8061 | | | | | | |
| 52 (B)/ | 1.4644 | 78 | 0.81 | 1.79 | 257 | −48 |
| 22.25 Photomer 8061/ | | | | | | |
| 22.25 Photomer 4003 | | | | | | |
| 26 (A)/ | 1.4653 | 46 | 1.08 | 2.12 | 196 | −46 |
| 26 (B)/ | | | | | | |
| 22.25 Photomer 8061/ | | | | | | |
| 22.25 Photomer 4003 | | | | | | |

^{a}Also contains 3% Irgacure 1850.
^{b}Peak in the tan δcurve from DMA at a frequency of 1 Hz.

All of the coatings prepared had excellent mechanical properties, exhibiting low modulus along with high tensile strength and high elongation. In particular, those coatings prepared using the double polyol block oligomer (B) had exceptionally low moduli and high elongation, while still having excellent tensile strength.

### EXAMPLE 2

In this example, it was demonstrated that a propylene oxide based monofunctional acrylate having the general structure as shown in A and B below can be formulated with oligomer systems such as urethane acrylates and epoxy acrylates to produce coating systems with at least two novel benefits, (1) low T_{g} and (2) low viscosity. In section B of example 2 it is shown that a reduction of 15° C. in T_{g} was achieved when a polypropylene oxide monomer was formulated into a coating. The resulting coating still maintained good mechanical strength, good flexibility, acceptable adhesion, and good hydrolytic and thermal stability. The viscosity of this monoacrylate can be selected to be low as shown in the following example. Therefore, it has good reducing and solvency characteristics and it can be easily formulated with a high molecular weight oligomer.

R₂—R₁—O—(CH₂CH₃CH—O)ₙ—COCH═CH₂ (A)

R₁—O—(CH₂CH₃CH—O)ₙ—COCH═CH₂ (B)

R₁, and R₂ could be aliphatic or aromatic or a mixtures of both, and n=1 to 10.

A) Low viscosity

Tripropylene glycol methylether monoacrylate, Photomer 8061, was one of the advantageous proposed in this invention. Its structure can be expressed as in Structure (2) when R₁=CH₃ and n=3. A comparison of viscosity between the above monoacrylates and a control (Photomer 4003) is listed in the following table.

TABLE 2-1

| | Control Monomer | Test Monomer |
|---|---|---|
| Viscosity @ 25° C. (cps) | 75-150 | 5-10 |

As can be seen, the test monomer has lower viscosity than the control monomer.

B) Low T_{g}

Urethane acrylate oligomer BR3731, from Bomar Specialities Company was used with the two monomers to prepare films for testing. 3 pph of Photoinitiator, Irgcure 1850 (Ciba Specialty Chemicals), was used in the coating recipes. In order to conduct compression and single cantilever test on a dynamic mechanical analyzer (hereinafter “DMA”), primary films of 1.3 mm in thickness were made. All the films were cured under a UV lamp (D bulb) with a dose about 5.6 J/cm². Degree of cure on the top and bottom of the film was determined by FTIR and results showed complete cure on both top and bottom surfaces. A comparison of T_{g} (Tan δ peak temperature) based on film/tension, single cantilever, and compression modes is shown as follows:

TABLE 2-2

| | Control Coating | Test Coating |
|---|---|---|
| T_{g} (° C.) film/tension | −13.7 | −30.1 |
| T_{g} (° C.) single cantilever | −3.9 | −20.7 |
| T_{g} (° C.) compression | +9.6 | −7.1 |

The following test methods were used in the present invention to determine the about T_{g}s. T_{g} was measured by DMA (DMA 2980 available from TA Instruments, New Castle, Del.) was operated under a fixed frequency of 1 Hz and amplitude of 6 mm using various clamp setups. The film tension clamp, single cantilever clamp, and compression clamp were used in determining the glass transition temperature of the coatings. The temperature range was from −100° C. to 100° C. and the ramp rate was at 5° C./min. The tensile properties were obtained using standard ASTM 882-97 method.

It is interesting to note that the T_{g} of the film range from about +9.6° C. to about −13.7° C. for the control containing Photomer4003 depending on the testing mode. As can be seen, the test coating including Photomer 8061 showed a reduction of T_{g} about up to about 17° C. by film/tension, single cantilever, and compression methods. Typically reductions were between about 15 to about 17° C. The benefit of this new formulation can be realized by its low T_{g} and hence its anticipated excellent low temperature microbend loss for optical fiber.

Thin films of 5 mils in thickness were also made. The result is shown as follows:

TABLE 2-3

| | Control Coating | Test Coating |
|---|---|---|
| T_{g} (° C.) film/tension | −34.4 | −47.9 |
| Tensile strength (MPa) | 0.85 | 0.97 |
| Young's modulus (Mpa) | 1.41 | 1.57 |
| Elongation % | 108.3 | 107.6 |

As expected, the new recipe shows a reduction of T_{g} by about 14° C. compared to the BR 3731/Photomer 4003 control using the same oligomer. The tensile properties such as tensile strength, elongation, and Young's modulus were quite similar to the control. The coating properties were tested in accordance with the aforementioned procedures.

### EXAMPLE 3

Low T_{g}, High Strength, and High Refractive Index

Urethane acrylate oligomer BR 3731, from Bomar Specialities Company was used as a control. Photomer 4003 (ethoxylated nonylphenol acrylate), one of the conventional fiber coating monomers, was received from Cognis Corporation. Photomer 8061, a propylene oxide containing monomer, was also received from Cognis Corporation. An experimental oligomer was synthesized having the structure

HEA˜(IPDI˜P₂₀₀₀˜IPDI)-T₂₀₀₀˜(IPDI˜P₂₀₀₀˜IPDI)˜HEA. (C)

To prepare oligomer (C), a mixture of 111.15 g (0.500 mole) of isophorone diisocyanate, 1.34 g of butylated hydroxytoluene (BHT) antioxidant and 1.35 g of di-n-butyltin dilaurate was placed in a 2000 ml resin reactor and stirred under nitrogen. The contents of the reactor were held at room temperature and 500.0 g (about 0.250 mole) of poly(propylene glycol) (Mₙ=2000) was added dropwise over 1 hour. The reactor was heated to an internal temperature of approx. 80 deg. C. for 1 hour, and then was allowed to cool to approx. 65 deg. C. Next, about 250.0 g poly(tetramethylene oxide) (about 0.125 moles) available as Terathane® 2000 from DuPont, Wilmington, Del. was added dropwise over 2.5 hours. The reactor was heated to an internal temperature of approx. 80 deg. C. for about 1 hour, and then was allowed to cool to approx. 65 deg. C. Then, about 29.03 g (0.250 mole) of 2-hydroxyethyl acrylate was added dropwise over 25 min. After the addition was complete, the reactor internal temperature was raised to approx. 80 deg. C. and held there for 2 hours to complete the reaction.

Irgacure 1850 (Ciba Specialty Chemicals) was used as the photoinitiator in the coating recipes. The oligomer/monomer/photoinitiator ratio—was fixed at 52/45/3 by weight in all studies. The coatings were prepared by weighing the oligomer (52% by weight) into a plastic mixing container followed by the addition of Photomer 8061 (Cognis, propoxylated methylether acrylate) as co-monomer (45%), and Irgacure 1850 (3%). The ingredients were mixed and then the container was placed in an oven and held at approximately 50-55 deg. C. for at least about 12 hours. The coatings were removed from the oven and stirred.

Films having a 1.3 mm thickness and films having a 0.1 mm thickness were prepared and cured using a UV lamp (D bulb). The UV doses were high enough to ensure full cure on the films (confirmed by FTIR). The films having 1.3 mm thickness were used in DMA film/tension, compression and single cantilever tests. On the other hand, the films having 0.1 mm thickness were used to obtain tensile properties and T_{g}. A comparison of T_{g} (Tan δ peak temperature) based on film/tension, single cantilever, and compression modes on the 1.3 mm thick films is shown as follows:

TABLE 3-1

| | | Test Oligomer C/ | BR3731/ |
|---|---|---|---|
| | Control | PH 8061 | PH 8061 |
| T_{g} (° C.) film/tension | −13.7 | −39.8 | −30.1 |
| T_{g} (° C.) single cantilever | −3.9 | −27.6 | −20.7 |
| T_{g} (° C.) compression | +9.6 | NA | −7.1 |

It is interesting to note that the T_{g} for all the films show a wide range depending on the test modes. As can be seen, the coating which included Photomer 8061 exhibited a reduction of T_{g} of about 15-17° C. by film/tension, single cantilever, and compression methods as compared to the control. Moreover, the T_{g} of the Oligomer C coating showed a 24-26° C. reduction in T_{g} as compared to the control. Thin films of 0.1 mm in thickness were used to obtain tensile properties using the standard ASTM method noted above. The same films were analyzed for T_{g} determination. The result is shown as follows:

TABLE 3-2

| | | Oligomer C/ | BR3731/ |
|---|---|---|---|
| | Control | PH 8061 | PH 8061 |
| T_{g} (° C.) tension | −34.4 | −55.7 | −47.9 |
| Tensile strength (Mpa) | 0.85 | 0.91 | 0.97 |
| Young's modulus (Mpa) | 1.41 | 1.45 | 1.57 |
| Elongation % | 108.3 | 122.1 | 107.6 |
| Refractive index | 1.481 | 1.454 | 1.455 |

As expected, the new recipe shows a reduction of T_{g} by about 14° C. compared to the control coating using the BR3731oligomer. The tensile properties such as tensile strength, elongation at break, and Young's modulus were quite similar to the control. The Oligomer C/Photomer 8061 shows a reduction in T_{g} by about 21° C. compared to the control while still maintaining good tensile strength and elongation at break.

Low Viscosity

A comparison of viscosity determined using a Brookfield viscometer at various temperatures for the three recipes is shown as follows:

TABLE 3-3

| | | Oligomer C/ | BR3731/ |
|---|---|---|---|
| | Control | PH 8061 | PH 8061 |
| Viscosity (cps) @ 25° C. | 8400 | 3210 | 1290 |
| Viscosity (cps) @ 45° C. | 2090 | 1160 | 490 |
| Viscosity (cps) @ 60° C. | 970 | 650 | 310 |

As can be seen, the Oligomer C/Photomer 8061 combination has a much lower viscosity than the control.

### EXAMPLE 4

### Microbend Attenuation Testing

In this example the microbend attenuation of two primary coatings, in which each coating included at least one test oligomer in combination with Photomer 8061, were evaluated. The test oligomers were as follows:

HEA˜H12MDI˜PPG₈₀₀₀˜H12MDI˜HEA; and (A)

HEA˜H12MDI˜PPG₄₀₀₀˜H12MDI˜PPG₄₀₀₀˜H12MDI˜HEA. (B)

The test methods included the lateral load wire mesh test (hereinafter “LLWM”) and the expandable drum test (hereinafter “EDT”). The EDM test is performed as follows. The test measures the slope of attenuation loss due to strain at different wavelengths of light. To perform the test, a length of fiber 750 m long is tension wound at 70 grams of tension in a single layer, with no crossovers on an expandable drum. The expandable drum surface is made from High Impact Polystyrene to prevent damage to the fiber and should be free of scratches and contaminates that could cause premature microbending to occur. The expandable drum is a drum with a unexpanded diameter of 30 cm (55 cm in length) that can be expanded uniformly to apply strain to the fiber wound on the drum. Each time the drum diameter was increased the diameter was increased about 2 mm or less. The diameter of the drum was expanded four times during the testing procedure.

The drum includes a mechanism that will allow a user to controllably apply a strain to the fiber on the drum by increasing the diameter of the drum having fiber wound onto the drum. The increase in diameter of the drum is controlled by the movement of an expansion element. To expand the diameter of the drum, the expansion element is turned 90° in a clockwise direction. Each time the expansion element is turned 90° the drum diameter is expanded. As the drum expands, an elongation force is applied to the fiber. An example of the elongation force applied to a sample of SMF-28™ fiber, in terms of percent strain, is listed in table II in terms.

TABLE II

| Degree of Turn of | % Strain |
|---|---|
| Expansion Element | (Sample size was 15) |
| 90° | ≧0.053 |
| 180° | 0.138 |
| 270° | 0.212 |
| 360° | ≦0.296 |

The data point for 90° is the minimum percent % for any one sample. Likewise, the data point for 360° is the maximum data point. The data points for 180° and 270° are the respective averages for each point.

The attenuation loss of the fiber is measured at wavelengths of 1310, 1550 and 1625 nm as initially wound on the drum and at the four strain increments of the expandable drum using a Photon Kinetics Model 2500 spectral attenuation bench-optical fiber analysis system (manufactured by Photon Kinetics of Beaverton, Oreg.). The user's manual for the model is herein incorporated by reference. The use of Model 2500 to perform the attenuation measurement is explained therein. The five measurements taken at each light wavelength of 1310, 1550 and 1625 nm are then plotted to determine the slope of attenuation loss due to strain.

The LLWM test is performed as follows. This test measures the spectral power of light launched through a fiber as a lateral load is applied to the fiber. Lateral load is a force normal to a cross section of the fiber. Each sample was tested 5 times.

A length of fiber is extended from a light source (a.k.a. launch stage) to a detector stage. A preferred detector stage is a Photon Kinetics (hereinafter “PK”) spectral attenuation measurement bench. A suitable device is Model 2500, optical fiber analysis system, from Photon Kinetics of Beaverton, Oreg. The user's manual for the model is herein incorporated by reference. The use of Model 2500 to perform the attenuation measurement is explained therein. The length of fiber must be sufficient to extend from the light source to the measurement bench. The length of fiber also should include a loose predetermined configuration of fiber disposed on an Instron® mechanical stress/strain measurement device as described below.

An Instron® mechanical measuring device is used to apply a lateral load on the fiber. The Instron® mechanical measuring device is a device capable of controllably applying a load on a material. The force of the load can be controlled and measured along with the rate of loading as a function of time. Further, the deformation imposed on the test sample of material (the piece of fiber) during the course of the loading event can be measured as well. For these tests an Instron® Model No. 4502 was used. This device was manufactured by Instron Corporation of Canton, Mass. Similar devices are available from other manufacturers.

The Instron® Model 4502 has a lower steel plate and an upper steel plate. The plates are oriented such that the force imposed by the upper plate on the lower plate is normal to the lower plate. The sample of fiber to be tested is placed on a rubber pad attached to the lower plate. The rubber pad has a shore A Hardness of 70+/−5. It is essential to ensure that the rubber pad is flat and not marked by grooves of any sort. If necessary, the pad should be replaced or cleaned with isopropyl alcohol.

The fiber is looped approximately 340 degrees around a mandrel having a diameter of 98.5 mm. The fiber may be held in place on a rubber pad by no more than three pieces of thin tape with a maximum width of 3 mm each. A portion of the tape is cut away to prevent fiber crossover at the point where the fiber ends exit the Instron® mechanical testing device.

The mandrel is removed and a number 70 wire mesh is placed on top of the fiber loop on the rubber pad, sandwiching the fiber between the rubber pad and the wire mesh. An initial attenuation of the fiber is recorded at 1310 nm, 1550 nm and 1625 nm. A compressive lateral load is applied to the fiber in increments of 10 N. The total lateral load applied is increased up to 70 N. The induced attenuation is recorded for each incremental increase in lateral load. The average change in attenuation is calculated for each incremental load between 30 N and 70 N. The test may also be used to record the change in attenuation in terms of change in decibels (Δ dB) at each of the three aforementioned wavelengths. The change in attenuation is measured in accordance with the cut back method.

The cutback method calculates the optical loss characteristics of a fiber by measuring the power received on the output side of the fiber at various lengths. The method includes launching an optical signal, of a relative strength, through a first end of the test fiber by the use of an optical source. A portion of the launched optical signal may travel in the cladding. The signal is detected at the end of the fiber and the power of the signal at the second end is measured. The signal is detected by use of an optical detector. The detector accounts for all of the light at the second end of the fiber, irrespective if the light was propagated in the core or the cladding.

The length of the fiber must be such that a detectable amount of signal is present at the second end of the fiber. This length of fiber is known as L₁. The fiber is cut to a length L₂, which is less than L₁. Once again an optical signal is transmitted through the fiber and the signal strength is detected at the second end of the fiber. The optical loss is determined based on the difference in signal strength for measurements at lengths L₁ and L₂. The optical loss is 10 log₁₀ (Power (L₂)/Power (L₁)). The attenuation is determined by dividing the optical loss by the difference in length between L₁ and L₂. The change in attenuation is measured as the load is applied in the same manner as the induced attenuation is measured.

Preparation of Test Coating 1 Including a PPG8000 Single Block Oligomer (A)

A mixture of 96.09 g (0.366 mole) of Bayer Desmodur W, 2.413 g of butylated hydroxytoluene (BHT) antioxidant and 2.420 g of di-n-butyltin dilaurate was placed in a 4000 ml resin reactor and stirred under nitrogen. The contents of the reactor were held at room temperature and 1465.0 g (0.183 mole) of Bayer Acclaim 8200 was streamed in over 5 h. The reactor was heated to an internal temperature of approx. 80 deg. C. for 1 h, and then was allowed to cool to approx. 65 deg. C. At this time 42.53 g (0.366 mole) of 2-hydroxyethyl acrylate was added dropwise over 28 min. After the addition was complete, the reactor internal temperature was raised to approx. 80 deg. C. and held there for 2 h to complete the reaction.

Upon completion of the above reaction with the oligomer (52% by weight of the final formulation) at approx. 80 deg. C. the heating mantle used during the synthesis was turned off with the resin reactor remaining inside the mantle. The coating was prepared by weighing 693.61 g of Photomer 4003 (Cognis, ethoxylated nonylphenol acrylate) and 693.61 g of Photomer 8061 (Cognis, propoxylated methylether acrylate) as co-monomers (45% by weight of the final formulation), 89.70 g Irgacure 1850 (3% by weight of the final formulation), and 29.90 Irganox 1035 (1 pph) in a 2000 ml beaker. The ingredients were mixed by hand and the contents were placed in an oven and held at approximately 50-55 deg. C. for 1 h. to facilitate the Irgacure 1850 and Irganox 1035 going into solution. After 1 h. the contents were added directly to the approx. 80 deg. C. oligomer and allowed to stir overnight to assure uniform mixing. The heating mantle was turned off but was retained to allow the formulation to cool slowly to room temperature and to ensure the Irgacure 1850 and Irganox 1035 were in solution. The next day the coating was removed from the resin reactor and transferred to a storage container. An adhesion promoter combination of 8.97 g 3-mercaptopropyl trimethoxysilane (0.3 pph) and 29.90 g bis(trimethoxysilylethyl) benzene (1 pph) was added and stirred into the coating over 1 h.

Preparation of Test Coating B Including a PPG4000 Double Block Oligomer (B)

A mixture of 140.69 g (0.536 mole) of Bayer Desmodur W, 2.425 g of butylated hydroxytoluene (BHT) antioxidant and 2.430 g of di-n-butyltin dilaurate was placed in a 4000 ml resin reactor and stirred under nitrogen. The contents of the reactor were held at room temperature and 1430.0 g (0.358 mole) of Bayer Acclaim 4200 was streamed in over 2.5 h. The reactor was heated to an internal temperature of approx. 80 deg. C. for 1 h, and then was allowed to cool to approx. 65 deg. C. At this time 41.51 g (0.358 mole) of 2-hydroxyethyl acrylate was added dropwise over 40 min. After the addition was complete, the reactor internal temperature was raised to approx. 80 deg. C. and held there for 2 h to complete the reaction.

Upon completion of the above reaction with the oligomer (52% by weight of the final formulation) at approx. 80 deg. C. the heating mantle used during the synthesis was turned off with the resin reactor remaining inside the mantle. The coatings was prepared by weighing 697.61 g of Photomer 4003 (Cognis, ethoxylated nonylphenol acrylate) and 697.61 g of Photomer 8061 (Cognis, propoxylated methylether acrylate) as co-monomers (45% by weight of the final formulation), 90.22 g Irgacure 1850 (3% by weight of the final formulation), and 30.22 g Irganox 1035 (1 pph) in a 2000 ml beaker. The ingredients were mixed by hand and the contents were placed in an oven and held at approximately 50-55 deg. C. for 1 hr to facilitate the Irgacure 1850 and Irganox 1035 going into solution. After 1 h the contents were added directly to the approx. 80 deg. C. oligomer and allowed to stir overnight to assure uniform mixing. The heating mantle was turned off but was retained to allow the formulation to cool slowly to room temperature and to ensure the Irgacure 1850 and Irganox 1035 were in solution. The next day the coating was removed from the resin reactor and transferred to a storage container. An adhesion promoter combination of 9.02 g 3-mercaptopropyl trimethoxysilane (0.3 pph) and 30.07 g bis(trimethoxysilylethyl) benzene (1 pph) was added and stirred into the coating over 1 h.

Evaluation of Coating Properties. Films of these formulations were cast and cured as described in D-16352. Film mechanical properties, viscosities and T_{g} values were measured as described in D-16352. Results are shown in the table below.

| | | Viscosity | Young's | Tensile | | |
|---|---|---|---|---|---|---|
| | | (Poise at | Modulus | Strength | Percent | T_{g} |
| | | 25 deg. C.) | (MPa) | (MPa) | Elongation | (deg. C.) |
| Test | 52 Oligomer A | 87 | 0.81 ± 0.05 | 1.79 ± 0.47 | 257 ± 24 | −47 |
| Coating 1 | 22.5 Photomer 8061/ | | | | | |
| | 22.5 Photomer 4003 | | | | | |
| Test | 52 Oligomer B | 86 | 0.82 ± 0.02 | 1.51 ± 0.20 | 263 ± 11 | −49 |
| Coating 2 | 22.5 Photomer 8061/ | | | | | |
| | 22.5 Photomer 4003 | | | | | |

Microbend Testing.
These formulations were used as primary coatings on SMF-28
fiber in combination with The following secondary coating

| | | |
|---|---|---|
| Oligomer | KWS4131 | 10% (Acrylate urethane oligomer) |
| Monomer | Photomer 4028 | 82% (ethoxylated bisphenol 4 diacrylate) |
| Monomer | Photomer 3016 | 5% (bisphenol A epoxy diacrylate) |
| Photo-initiator | Irgacure 819 and 184 | 3% (50/50 Blend) |
| Antioxident | Irganox 1035 | 0.5 pph |

The performance of each testing coating was compared to a urethane acrylate dual coating system available from DSM Desotech of Elgin, Ill. Each coating sample was applied to a sample of SMF-28™ fiber available from Corning Incorporated of Corning, N.Y. For comparison purposes, control 1 and test coating 1 were drawn from the same blank as was as were test coating 2 and control coating 2.

The microbend test results are shown below in tables 4-1 and 4-2.

### Lateral Load Microbend Testing (dB/m)—Measured 70-30N LLWM Values

TABLE 4-1

| Fiber/ | MFD (um) @ | 1310 nm | | 1550 nm | | 1625 nm | |
|---|---|---|---|---|---|---|---|
| Coating ID | 1310 nm | 70-30N | ( ± 1□□ | 70-30N | ( ± 1□□ | 70-30N | ( ± 1□□ |
| Control 1 | 9.36 | 0.527 | 0.081 | 1.025 | 0.157 | 1.356 | 0.178 |
| Test | 9.35 | 0.113 | 0.022 | 0.254 | 0.054 | 0.417 | 0.061 |
| Coating A | | | | | | | |
| Control 2 | 9.14 | 0.293 | 0.062 | 0.577 | 0.072 | 0.879 | 0.108 |
| Test | 9.15 | 0.096 | 0.046 | 0.233 | 0.111 | 0.302 | 0.145 |
| Coating B | | | | | | | |

### EXPANDABLE DRUM RESULTS

TABLE 4-2

| | | Slope | | |
|---|---|---|---|---|
| | | Loss due to Strain | | |
| Fiber/ | MFD (um) | (dB/km)/% Strain | | |
| Coating ID | @ 1310 nm | 1310 nm | 1550 nm | 1625 nm |
| Control 1 | 9.36 | 0.718 | 2.297 | 3.832 |
| Test Coating 1 | 9.35 | 0.064 | 0.124 | N/A |
| Control 2 | 9.14 | 0.347 | 1.136 | 2.155 |
| Test Coating 2 | 9.15 | 0.026 | 0.165 | 0.409 |

The test coatings consistently exhibited superior microbend performance as compared to the control coatings.

While the invention has been described with preferred embodiments, it is to be understood that variations and modifications may be resorted to as will be apparent to those skilled in the art. Such variations and modifications are to be considered within the purview and the scope of the claims appended hereto.

What is claimed is:

1. A curable coating composition comprising:
at least one oligomer comprising a polyol soft block having a number average molecular weight of more than about 4000 and at least one reactive monomer, wherein said composition has a cured coating tensile strength of at least about 0.85 MPa and a Young's Modulus of less than about 1.3 MPa.

2. The coating composition of claim 1, wherein said polyol has a number average molecular weight of at least about 8000.

3. The coating composition of claim 1, wherein said polyol comprises at least one moiety of polypropylene glycol having a number average molecular weight of at least about 4000.

4. The coating composition of claim 1, wherein said oligomer comprises:
HEA˜H12MDI˜PPG₄₀₀₀˜H12MDI˜HEA, where PPG₄₀₀₀ comprises a polypropylene glycol having a number average molecular weight of approximately 4000 and a molecular weight distribution of less than about 1.1, H12MDI comprises 4,4′-methylenebis(cyclohexylisocyanate), and HEA comprises 2-hydroxyethyl acrylate.

5. The coating composition of claim 1, wherein said oligomer comprises:
HEA˜H12MDI˜PPG₄₀₀₀˜H12MDI˜PPG₄₀₀₀˜H12MDI˜HEA, where PPG₄₀₀₀ comprises a polypropylene glycol having a number average molecular weight of approximately 4000 and a molecular weight distribution of less than about 1.1, H12MDI comprises 4,4′-methylenebis(cyclohexylisocyanate), and HEA comprises 2-hydroxyethyl acrylate.

6. The coating composition of claim 1, wherein said oligomer comprises:
HEA˜(IPDI˜PPG₂₀₀₀˜IPDI)˜T₂₀₀₀˜(IPDI˜PPG₂₀₀₀˜IPDI)˜HEA, where HEA comprises hydroxyethyl acrylate, IPDI comprises isophorone diisocyanate, PPG₂₀₀₀ comprises poly(propylene glycol) with a Mₙ of about 2000 and T₂₀₀₀ comprises poly(tetramethylene glycol) with a Mₙ of about 2000.

7. The coating composition of claim 1, wherein said oligomer is substantially devoid of a polyurea group (—N(C═O)N—).

8. The coating composition of claim 1, wherein said monomer is a tripropylene glycol methylether monoacrylate.

9. The coating composition of claim 1, wherein said monomer comprises:
R₂—R₁—O—(CH₂CH₃CH—O)ₙ—COCH═CH₂, where R₁ and R₂ are aliphatic, aromatic, or a mixture of both, and n=1 to 10.

10. The coating composition of claim 1, wherein said monomer comprises:
R₁—O—(CH₂CH₃CH—O)ₙ—COCH═CH₂, where R₁ is aliphatic or aromatic, and n=1 to 10.

11. The coating composition of claim 1, further comprising a monomer having a branched polyoxyalkylene chain.

12. The coating composition of claim 1, wherein said monomer comprises propylene oxide acrylates, n-propylene oxide acrylates, iso-propylene oxide acrylates, substituted iso-propylene oxide acrylates, substituted alkoxy alkyl alkenes, propylene oxide ethoxylated oxides, or combinations thereof.

13. The coating composition of claim 1, wherein said composition when cured comprises a Young's Modulus of about 1.28 MPa or less and a tensile strength of at least about 1 MPa.

14. The coating composition of claim 13, wherein said composition comprises a Young's Modulus of about 1.25 MPa or less.

15. The coating composition of claim 13, wherein said composition comprises a Young's Modulus of about 1 MPa or less.

16. The coating composition of claim 13, wherein said composition comprises a tensile strength of at least about 1.5 MPa.

17. The coating composition of claim 13, wherein said composition comprises a tensile strength of at least about 1.75 MPa.

18. The coating composition of claim 13, wherein said composition comprises a viscosity at 25° C. of less than about 80 poise.

19. The coating composition of claim 14, wherein said composition comprises a viscosity at 25° C. of less than about 50 poise.

20. The composition of claim 1, further comprising a photoinitiator.

21. The composition of claim 1, further comprising at least one of an adhesion promoter, reactive diluent, antioxidant, catalyst, stabilizer, property-enhancing additive, wax, lubricant, and slip agent.

22. A coated optical fiber comprising an optical fiber having a primary coating layer thereon comprising the polymerized product of at least one oligomer comprising a polyol soft block having a number average molecular weight of more than about 4000 and at least one reactive monomer, wherein said cured coating has a tensile strength of at least about 0.85 MPa and a Young's Modulus of less than about 1.3 MPa.

23. The coated fiber of claim 22, wherein said polyol has a number average molecular weight of at least about 8000.

24. The coated fiber of claim 22, wherein said polyol comprises at least one moiety of polypropylene glycol having a number average molecular weight of at least about 4000.

25. The coated fiber of claim 22, wherein said oligomer comprises:
HEA˜H12MDI˜PPG₄₀₀₀˜H12MDI˜HEA, where PPG₄₀₀₀ comprises a polypropylene glycol having a number average molecular weight of approximately 4000 and a molecular weight distribution of less than about 1.1, H12MDI comprises 4,4′-methylenebis(cyclohexylisocyanate), and HEA comprises 2-hydroxyethyl acrylate.

26. The coated fiber of claim 22, wherein said oligomer comprises:
HEA˜H12MDI˜PPG₄₀₀₀˜H12MDI˜PPG₄₀₀₀˜H12MDI˜HEA, where PPG₄₀₀₀ is a polypropylene glycol having a molecular weight of approximately 4000 and a molecular weight distribution of less than about 1.1, H12MDI is 4,4′-methylenebis(cyclohexylisocyanate), and HEA is 2-hydroxyethyl acrylate.

27. The coated fiber of claim 22, wherein said oligomer comprises:
HEA˜(IPDI˜PPG₂₀₀₀˜IPDI)˜T₂₀₀₀˜(IPDI˜PPG₂₀₀₀˜IPDI)˜HEA, where HEA comprises hydroxyethyl acrylate, IPDI comprises isophorone diisocyanate, PPG₂₀₀₀ comprises poly(propylene glycol) with a Mₙ of about 2000 and T₂₀₀₀ comprises poly(tetramethylene glycol) with a Mₙ of about 2000.

28. The coated fiber of claim 22, wherein said oligomer is substantially devoid of a polyurea group (—N(C═O)N—).

29. The coated fiber of claim 22, wherein said monomer is a tripropylene glycol methylether monoacrylate.

30. The coated fiber of claim 22, wherein said monomer comprises:
R₂—R₁—O—(CH₂CH₃CH—O)ₙ—COCH═CH₂, where R₁ and R₂ are aliphatic, aromatic, or a mixture of both, and n=1 to 10.

31. The coated fiber of claim 22, wherein said monomer comprises:
R₁—O—(CH₂CH₃CH—O)ₙ—COCH═CH₂, where R₁ is aliphatic or aromatic, and n=1 to 10.

32. The coated fiber of claim 31, further comprising a monomer having a branched polyoxyalkylene chain.

33. The coated fiber of claim 22, wherein said monomer comprises propylene oxide acrylates, n-propylene oxide acrylates, iso-propylene oxide acrylates, substituted iso-propylene oxide acrylates, substituted alkoxy alkyl alkenes, propylene oxide ethoxylated oxides, or combinations thereof.

34. The coated fiber of claim 22, wherein said cured coating has a Young's Modulus of about 1.28 MPa or less and a tensile strength of at least about 1 MPa.

35. The coated fiber of claim 22, wherein said cured coating has a Young's Modulus of about 1.25 MPa or less.

36. The coated fiber of claim 22, wherein said cured coating has a Young's Modulus of about 1 MPa or less.

37. The coated fiber of claim 22, wherein said cured coating has a tensile strength of at least about 1.5 MPa.

38. The coated fiber of claim 22, wherein said cured coating has a tensile strength of at least about 1.75 MPa.

39. A method for making a coated optical fiber, comprising:
providing an optical fiber;
coating the optical fiber with a polymerizable composition comprising at least one oligomer comprising a polyol soft block having a number average molecular weight of more than about 4000, and at least one reactive monomer; and
polymerizing the composition under conditions effective to form a primary coating over the optical fiber wherein said cured composition has a coating tensile strength of at least about 0.85 MPa and a Young's Modulus of less than about 1.3 MPa.

40. The method of claim 39, further comprising coating the optical fiber with a secondary polymerizable composition over said primary coating.

41. The method of claim 40, wherein said coating of the optical fiber with a secondary polymerizable composition is carried out prior to said polymerizing, whereby said polymerizing simultaneously polymerizes said polymerizable compositions.

42. The method of claim 40, wherein said coating of the optical fiber with a secondary polymerizable composition is carried out after said polymerizing and further comprises polymerizing the secondary polymerizable composition after it is applied to the glass fiber.

43. The coating composition of claim 1, wherein said polyol comprises a molecular weight distribution of less than about 1.1.

44. The coating composition of claim 1, wherein said composition comprises a viscosity at 25° C. of less than about 970 cps.

45. The coating composition of claim 1, wherein said monomer comprises a branched polyoxyalkylene chain.

46. A curable coating composition comprising:
at least one oligomer comprising a polyol soft block having a number average molecular weight of more than about 4000 wherein in said oligomer comprises at least one of the oligomers selected from HEA-H12MDI-PPG₄₀₀₀-H12MDI-HEA; HEA-H12MDI-PPG₄₀₀₀-H12MDI-PPG₄₀₀₀-H12MDI-HEA; HEA-(IPDI-PPG₂₀₀₀-IPDI)-T₂₀₀₀-(IPDI-PPG₂₀₀₀-IPDI)-HEA; HEA-(IPDI-T₂₀₀₀-IPDI)-PPG₂₀₀₀-(IPDI-T₂₀₀₀-IPDI)-HEA; HEA-(IPDI-PPG₂₀₀₀-IPDI)-BD-(IPDI-PPG₂₀₀₀-IPDI)-HEA; HEA-(IPDI-BD-IPDI)-PPG₂₀₀₀-(IPDI-BD-IPDI)-HEA; HEA-(IPDI-EG₄-IPDI)-PPG₂₀₀₀-(IPDI-EG₄-IPDI)-HEA; HEA-H12MDI-PPG₈₀₀₀-H12MDI-HEA; and
combinations thereof wherein HEA comprises a hydroxyethyl acrylate capping group, IPDI comprises a diisocyanate, PPG₂₀₀₀ comprises a poly(propylene glycol) with a Mₙ=2000, T₂₀₀₀ comprises a poly(tetramethylene glycol) with a Mₙ=2000, BD comprises a butanediol, EG₄ comprises a tetraethylene gylcol, and PPG₄₀₀₀ comprises a poly(propylene glycol) with a Mₙ=4000, and H12MDI comprises an isocyanate at least one reactive monomer, wherein said composition has a cured coating tensile strength of at least about 0.85 MPa and a Young's Modulus of less than about 1.3 MPa.
